(19) United States
(12) Patent Application Publication
(10) Pub. No.: US 2014/0052648 A1
(43) Pub. Date: Feb. 20, 2014

(54) System and method for intellectual property management

(71) Applicant: Teresa Lavonne Pointer, Chicago, IL (US)

(72) Inventor: Teresa Lavonne Pointer, Chicago, IL (US)

(21) Appl. No.: 13/694,507

(22) Filed: Dec. 6, 2012

Related U.S. Application Data
(60) Provisional application No. 61/630,198, filed on Dec. 6, 2011.

(51) Int. Cl. G06Q 50/18; G06Q 10/10

(52) U.S. Cl. CPC G06Q 50/184; G06Q 10/10
USPC 705/310

(57) ABSTRACT

The Intellectual property management system is a membership based system that guides members through the process of discovery and understanding of the steps necessary to take their creation from a solution on a piece of paper to a patent pending asset that can be promoted nationwide and licensed for monetization. Through self-paced online training sessions and materials, members can learn how to prepare their patent application without disclosing their intellectual property to anyone.

### CROSS REFERENCE TO RELATED APPLICATIONS

This patent application claims the benefit of U.S. Provisional Patent Application Ser. No 61/630,198, entitled “System and method for intellectual property management” to Teresa Pointer, et. al and filed on Dec. 6, 2011, which is fully incorporated herein by reference as describing and illustrating subject matter (in part(s) or in its entirety) that can be practiced with the subject matter disclosed herein.

### FIELD OF THE INVENTION

The present invention relates generally to intellectual property management, and more particularly to enabling individuals to manage the lifecycle of their own intellectual property and providing a reduced cost means of obtaining access to patents, marketing of inventions, and licensing of inventions.

### BACKGROUND

For years, individuals, and small businesses alike have struggled with balancing their desire to protect their inventions with the high upfront costs associated with obtaining a patent. Countless inventive solutions have fallen by the wayside, or worse, been “rediscovered” or capitalized upon by larger corporations who have the legal and financial resources to churn out patent applications for the inventions of their employees and engineers.

An individual's ability to either navigate the patenting process themselves, or pay the thousands of dollars required to retain a patent professional is a huge barrier for the average individual or small business who has a great idea or invention.

Whether attempting to complete the patenting process themselves, or hiring a patent professional, many inventors still do not feel 100% assured that their intellectual property will not be stolen from them by anyone who has access to it, including their attorneys. Even having signed non-disclosure agreements does not alleviate the possibility of theft or misuse of confidential information the inventor may share. Any means of reducing the possibility of intellectual property theft would greatly increase an inventor's comfort level in preparing their patent application and exposing their invention to the world.

Even after an individual or small business is successful in navigating the patent process and obtains a patent or reaches patent pending status, there still looms ahead an even larger obstacle: getting their invention in front of the right people in order to license their invention or to obtain funding to produce or manufacture the product themselves. There are almost eight million patents issued by the patent office but only a small percentage of the issued patents ever reach the marketplace where consumers or businesses are ready and willing to pay for the solutions that the patents provide.

### SUMMARY

This summary is provided to introduce a selection of concepts in a simplified form that are further described below in the detailed description of embodiments. This summary is not intended to identify all of the key features of the business model, nor is it intended to be used to limit the scope of the claimed subject matter.

The Intellectual Property Management System is an internet based membership system that provides access to intellectual property information and resources to its membership. This proprietary model groups inventors together for services, and effectively pools system resources to reduce costs to an annual membership and filing fees that all can afford. Using this system and method, members can learn how to prepare and file their patent application, as well as to utilize the membership resources for promotion of their invention to monetize their patent.

The Intellectual Property Management System uses three integrated subsystems: patenting, marketing, and infrastructure, working together to allow the everyday inventor access to a global market for their solutions. The patenting subsystem addresses the IP related member training, training materials, and attorney consultations. The marketing subsystem handles the member recruitment, invention marketing and invention promotion. The infrastructure subsystem handles member care, website development and maintenance, and overall IT solutions.

### DESCRIPTION OF THE FIRST EMBODIMENT

While the system will be described in connection with an example embodiment, it will be understood that the example embodiment is not intended to limit the system to this embodiment. On the contrary, it is intended as an example of the system, which has various alternative embodiments, modifications, and equivalents that are all included within the spirit and scope of this application.

In an example embodiment, the intellectual property management system and method is shown as follows:

An individual receives an invitation to join an online membership based organization of inventors who share a common goal: taking their creation to the market after establishing ownership of their intellectual property through the patent process. After viewing the information and learning about all of the benefits of membership, the individual makes a decision on whether to join the membership community.

When the individual decides to enroll with an annual membership, they are immediately granted access to several online video training sessions to provide them with the information and steps necessary to move forward towards obtaining a patent and marketing their invention. The training is provided in digestible sections of information, so that the necessary building blocks are put in place to determine the area/category of the market for their invention, determine the market potential for their invention, and determine the cost and price range for items similar to their invention. Additionally, information is provided in patent related subject areas such as: an introduction to patents and intellectual property, creating invention disclosures, conducting a preliminary patent search, creating drawings, determining patent classifications for your invention, using non-disclosure agreements, creating/using work for hire agreements, writing the patent specification, when and how to apply for a trademark, and various other relevant subject areas.

The information and resources provided to each member enables them to receive the information necessary to move forward with the patenting process in the privacy of their own homes via a computer or other internet capable device without having to disclose their invention until they are ready to do so. In an ideal situation, the member could use the training and information received to draft their specification, make the necessary drawings, complete the necessary filing forms, and even submit their patent application without having disclosed their invention to anyone prior to filing with the patent office. This empowerment of the individual member greatly increases the comfort level of those who might be afraid of their invention being stolen.

After the member completes the patent application process, the member could also use membership training resources to file their trademark application. Their invention would also be promoted by the organization. Promotion of member's inventions on a national or international scale would greatly increase exposure of their solutions to the market and improve the likelihood of successful monetization of their intellectual property. When a members patent is licensed or monetized a pre-arranged percentage of the income would be returned to the organization.

### DESCRIPTION OF ALTERNATE EMBODIMENTS

In an alternative embodiment, each member has the ability to obtain additional information, attend live on-line training, and even meet with a patent attorney for review of their progress after reaching specific milestones within the patenting process.

In another embodiment, the members receive the additional benefit of having their invention marketed for a minimal cost once their patent application is filed.

In another embodiment, the members receive the additional benefit of patent counsel reviewing existing products and patent applications to protection against potential infringers of their patented inventions.

In another embodiment, the membership is multi-tiered, where members have the option to purchase a second tier or third tier membership that entitles them to access benefits and resources that are not provided with the first tier membership. For example, for an additional annual cost the second tier members are provided 10 hours of consultation time with the association's staff of patent attorneys. A member choosing to purchase a third tier membership would receive all of the benefits of the first and second tier, and additionally be eligible to participate in an invention funding and production company that will manufacture and take to market selected inventions.

Although the descriptions above contain much specificity, they should not be construed as limiting the scope of the invention, but as merely providing illustrations of some of the presently preferred embodiments of the Intellectual Property Management System. Many other variations and modifications will be apparent to those skilled in the art, including the ability to promote the members inventions online from their customized webpage.

### OBJECTS AND ADVANTAGES

It is a general object of this invention to provide an infrastructure for an internet based membership system that empowers members to own and manage their intellectual property.

It is also an object to provide a low cost means of monetizing your intellectual property through obtaining ownership of patents and trademarks.

It is also an object of this invention to provide individuals with access to patent related information in an understandable and easy to implement format.

It is another object to provide individuals with resources for taking their inventions to market once a patent or patent pending status is obtained.

A further object of the invention is to enable members to establish a vehicle for creating generational wealth through ownership and management of their intellectual property.

Another object of the invention is to provide an online system for patenting assistance that does not require members to disclose their inventions to anyone prior to filing.

It is also an object of this invention to provide individuals with a system to translate their idea into an invention, and to assist them through the process of transforming their invention into a marketable intellectual property asset, then assist the member in the process of promoting and marketing their product so that their intellectual property can be monetized through licensing royalties.

It is a further object of the invention to harness the power of membership volume to decrease the costs of creating, patenting, prototyping, trademarking, and marketing an invention for the individual person.

Other additional objects and advantages of the invention will become apparent upon reading the following detailed description and upon reference to the drawing figure.

### BRIEF DESCRIPTION OF DRAWING

FIG. 1 illustrates the process flow for an embodiment of the business model.

### DETAILED DESCRIPTION OF DRAWING

Certain embodiments of the present invention provide system and method for managing intellectual property. In some embodiments, the system provides resources and information necessary to complete the patent application process.

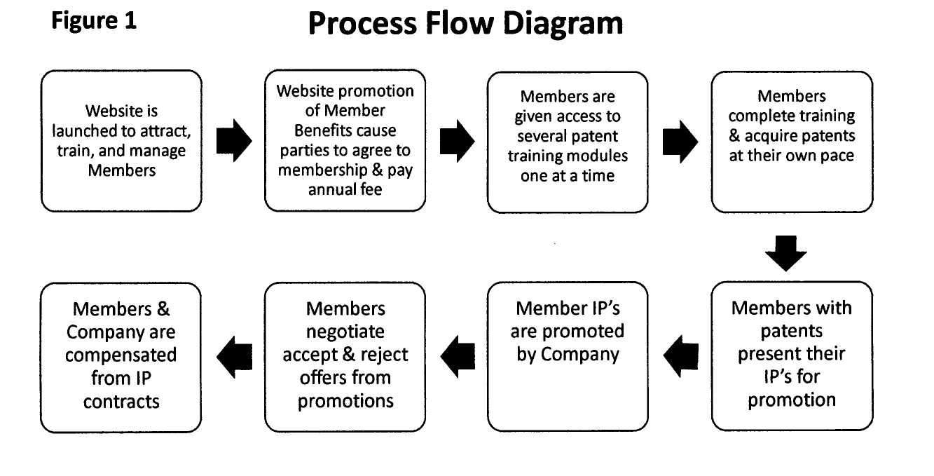

FIG. 1 illustrates the proprietary process steps for the Intellectual Property Management System. The system infrastructure provides the website as a platform for attracting, training and managing the members of the system. Once members have joined, they are provided access to the training modules. Once they complete the training and file their application, the member's invention can be promoted to the market. Exposure to the market results in offers to license or purchase their IP. Resulting contracts compensate members and the organization.

We claim:

1. An internet based system and method for management of intellectual property for implementation upon a digital computer comprising:
allowing a user to access information on intellectual property via a website;
allowing a user to access training materials related to translating ideas for inventions into intellectual property assets via a computer having internet capability; and
providing an explanation of the steps necessary to complete a patent or trademark application.

2. The internet based system and method of claim 1, further including requiring a user to obtain a fee based membership to access said website.

3. The internet based system and method of claim 2, further including providing the user access to patent professionals as needed to address issues that arise.

4. The internet based system and method of claim 2, further including providing the user with the forms necessary to file a patent or trademark application.

5. The internet based system and method of claim 3, further including providing the user with instructions on completing the forms necessary to file a patent application.

6. A computer based intellectual property management system configured to allow an inventor to file one or more patent applications comprising:
a website for users to access patent related information;
a means for storage of a series of training videos for drafting a patent application; and
a means for providing assistance with completing the patent application process.

7. The computer based intellectual property management system of claim 6, wherein the user must become a member of an intellectual property association in order to access the website.

8. The computer based intellectual property management system of claim 6, wherein the means for storage comprises a server or a database.

9. The computer based intellectual property management system of claim 6, wherein the means for providing assistance includes providing sample forms that have been completed with exemplary information.

10. The computer based intellectual property management system of claim 7, wherein the means for providing assistance includes providing patent professionals to answer questions from association members via telephone or email.

11. The computer based intellectual property management system of claim 10, wherein the member can complete their patent application without disclosing their invention to another individual prior to filing their application.

12. A process for intellectual property management implemented on a computer or smart device comprising:
providing a website or mobile application to attract, manage and train individuals on intellectual property issues;
providing training materials for online access by individuals at their convenience; and
providing online assistance with completing the various sections of a patent application.

13. The process of claim 12 wherein a membership fee is required to access the website or mobile application.

14. The process of claim 13 wherein a multi-tiered membership is offered comprising;
providing a first tier membership wherein patenting information and online training is provided;
providing a second tier membership wherein online patent professional support is added to first tier benefits;
and providing a third tier membership wherein invention marketing and prototype development support is added to second tier benefits.

15. The process of claim 12 further including providing online assistance with completing patent application forms.

16. The process of claim 13 further including providing online assistance with completing the trademark application process.

17. The process of claim 13 further including providing members with the option to participate in an invention funding and invention manufacturing company for an additional fee.
